(19) United States
(12) Patent Application Publication
(10) Pub. No.: US 2006/0150243 A1
(43) Pub. Date: Jul. 6, 2006

(54) Management of network security domains

(75) Inventors: Simon Michael French, Portsmouth (GB); Timothy John Merriman, Portsmouth (GB); Gary David List, Portsmouth (GB); Jeremy Charles Creasey, Portsmouth (GB); Philip John Coqueral, Portsmouth (GB); Roger Michael Wright, Portsmouth (GB)

Correspondence Address: CROWELL & MORING LLP;INTELLECTUAL PROPERTY GROUP, P.O. BOX 14300, WASHINGTON, DC, 20044-4300, US

(73) Assignee: BAE Systems (Defence Systems) Limited, Farnborough (GB)

(21) Appl. No.: 10/531,310

(22) PCT Filed: Nov. 12, 2003
(86) PCT No.: PCT/GB03/04889

§ 371 Date: Nov. 21, 2005

(30) Foreign Application Priority Data
Nov. 20, 2002 (GB) 0227049.4

(51) Int. Cl. G06F 15/16

(52) U.S. Cl. 726/11

(57) ABSTRACT

Described herein is a system for the management of security domains. The system comprises a managing security domain (10), a firewall (70) and two or more managed security domains (80, 100). The managing security domain (10) includes a plurality of nodes (12, 14, 16) of which one is a management node (16) for managing the domain (10). Each managed security domain (80, 100) comprises a plurality of nodes (82, 84, 102, 104). The management node (16) operates in conjunction with the firewall (70) to manage the managed domains, the firewall (70) allowing the transfer of information across domains having different security levels.

The present invention relates to management of network security domains, and is more particularly concerned with secure network management across domains of different security and the control of network traffic between and across such domains.

A domain is an area of one or more networks. In the domain based security model, the domains are isolated from one another so that communication between networks that contain operational data at different security levels is not possible. Each security domain has a management node that manages nodes within the domain. The management node checks the status of the nodes and updates their configuration as required. The reason each domain needs a management node is because no information can pass between separate security domains. This means that for each security domain a management node has to be provided. Generally, a management node is a PC and a managed node may be another PC, router or any other device including a microprocessor or computer.

It is an object of the present invention to provide secure network and system management of domain based systems in order to overcome the problem of having a management node for each security domain.

It is another object of the present invention to provide secure management of the nodes on a plurality of security domains from one or more management nodes on other security domains.

In accordance with one aspect of the present invention, there is provided a system for managing security domains, the system comprising:

a plurality of security domains, each domain comprising at least one network having a plurality of managed nodes provided therein;

at least one management node located in one of said plurality of security domains for controlling operation of said plurality of managed nodes in said one security domain; and

a firewall located external of said one security domain which is operationally linked to the management node in said one security domain, the firewall linking said management node with said plurality of managed nodes in said plurality of security domains.

In the present context, a domain is a specific area consisting of one or more networks amongst a larger collection of networks. In the domain based security model, the security domains are securely isolated from each other such that no traffic may pass between them.

In accordance with the present invention, each security domain no longer requires its own unique management node. The present invention is, however, able to provide a channel for the remote management without compromising the secure separation of the domains. This is due to controls which are enforced on network traffic, and more specifically and uniquely, the control of network traffic by examining the path of that traffic as determined by the source and destination addresses and the operational content contained within that traffic.

The present invention permits only authorised network traffic between a security domain containing a management node and a security domain containing nodes to be managed by that management node. The invention does not permit any network traffic between security domains which do not contain a management node.

Advantageously, the firewall controls the network traffic by examining the source of the traffic, the destination of the traffic, and the operational content contained within that traffic.

Preferably, the firewall converts one management protocol to another.

The firewall may host Simple Network Management Protocol (SNMP). In this case, when the managing security domain hosts one version of SNMP and at least one of the managed security domain hosts another version of SNMP, the firewall converts one version of SNMP to another.

In one embodiment, the managing security domain hosts several versions of SNMP and the managed security domains hosts less secure versions of SNMP. For example, the firewall may convert SNMPv3 on the managed security domain to SNMPv2c on the managed security domains.

As an alternative or addition, the firewall may host a subset of Internet Control Management Protocol (ICMP).

It is a further advantage of the present invention that the firewall prevents communication between one managed security domain and any other managed security domain. Moreover, the firewall controls access of information on each node in a managed security domain.

In accordance with another aspect of the present invention, there is provided a method of centralising access control information on managed nodes in a system for managing security domains as described above.

For a better understanding of the present invention, reference will now be made, by way of example only, to the accompanying drawings in which:

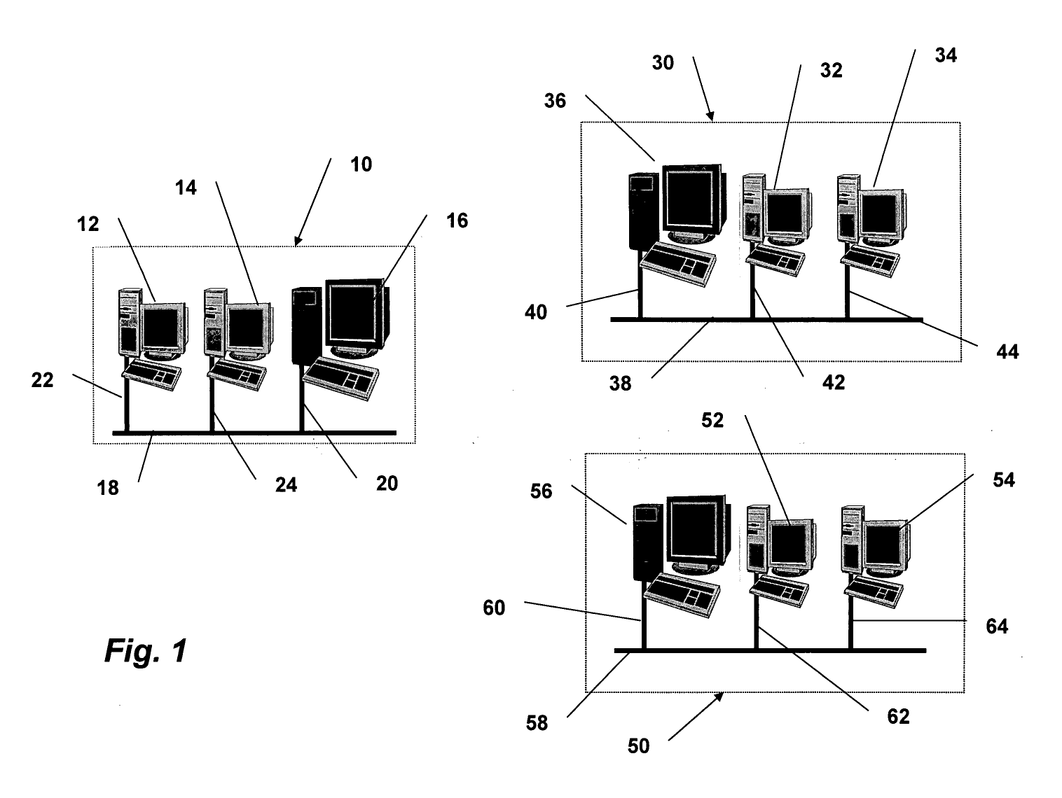

FIG. 1 illustrates a conventional security domain arrangement for three security domains;

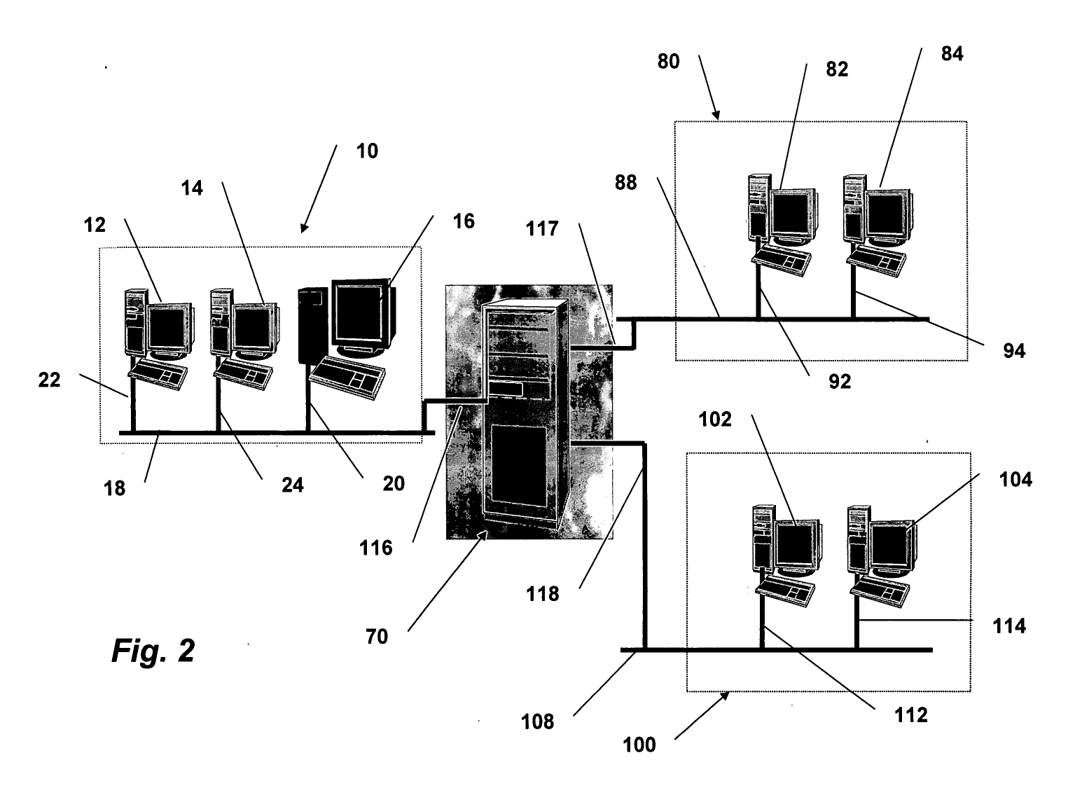

FIG. 2 illustrates a security domain arrangement for three security domains in accordance with the present invention;

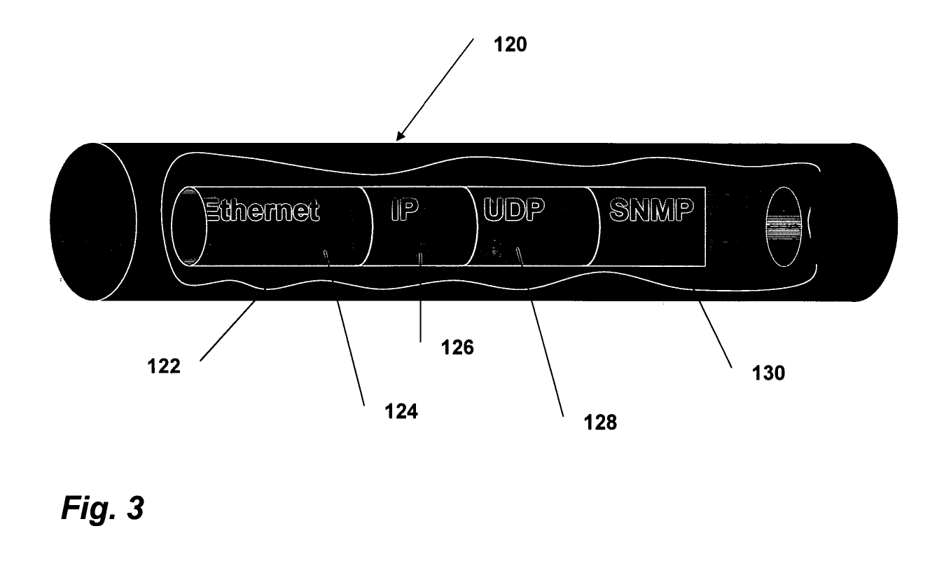

FIG. 3 illustrates the functionality of an interface used with the security domain arrangement of FIG. 2 for SNMP traffic;

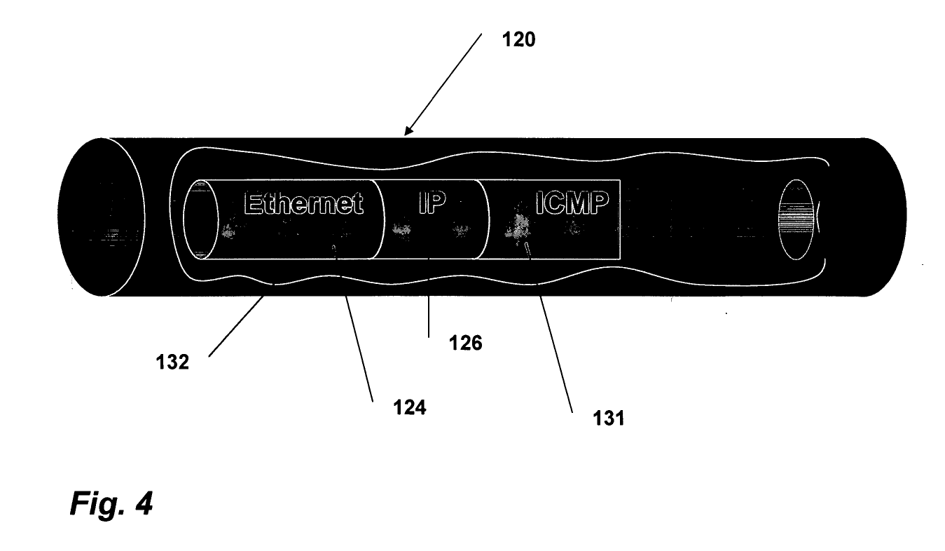

FIG. 4 illustrates the functionality of an interface used with the security domain arrangement of FIG. 2 for ICMP traffic;

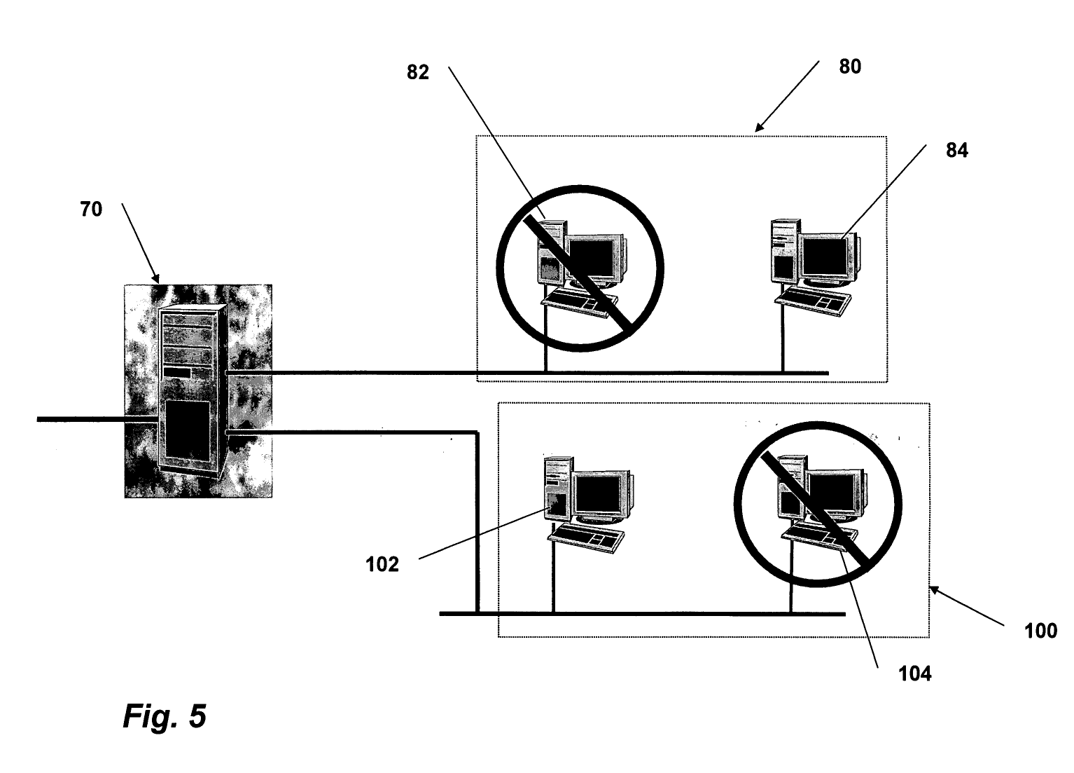

FIG. 5 illustrates host access control in the managed security domains of FIG. 2; and

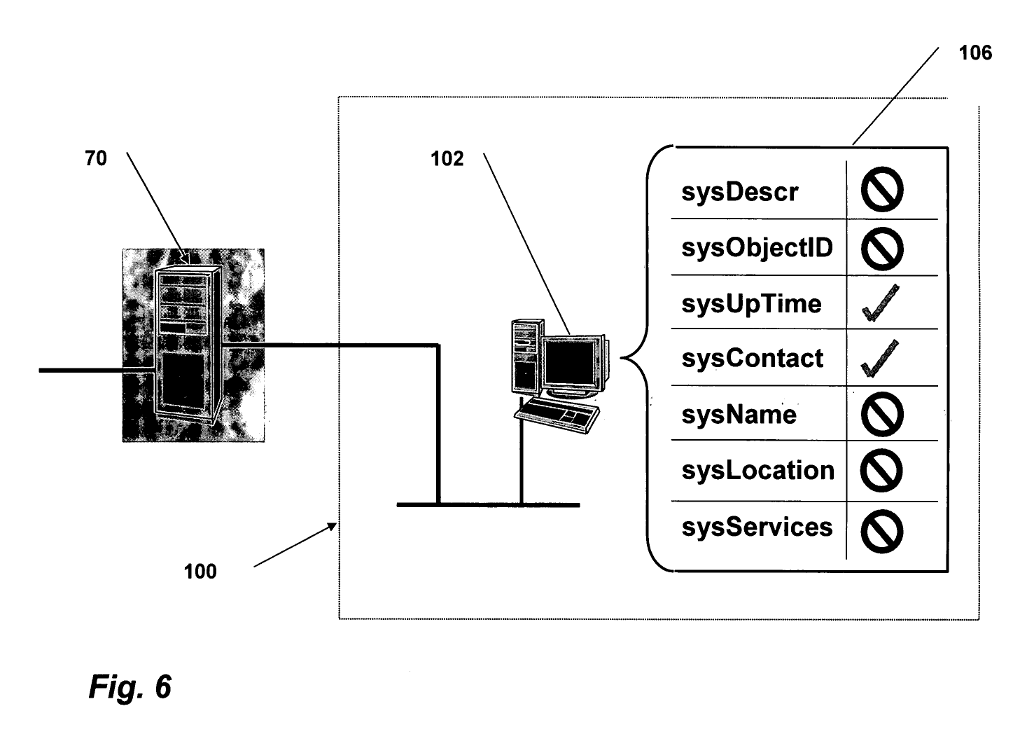

FIG. 6 illustrates host access control of management information in accordance with the present invention.

Industry Internet standard protocols such as Simple Network Management Protocol (SNMP) and Internet Control Management Protocol (ICMP) may allow information to be transferred from one network to another. SNMP is currently the most widely used open standard management protocol in networking, for example, Windows NT (Trademark of the Microsoft Corporation) comes with the SNMP service installed as standard. ICMP echo requests are also supported as a rudimentary way of checking network connections between machines.

In a preferred embodiment of the present invention, a Trusted Solaris 2.5.1 operating system is used. This operating system is a UNIX based system, and it will be appreciated that any other UNIX based operating system may be used.

In addition to the Trusted Solaris 2.5.1 operating system, a firewall toolkit is utilised. In the embodiment of the invention described below, the firewall toolkit is the Switch IP Secure|Y (SWIPSY) firewall toolkit developed by the former Defence Evaluation and Research, Agency (DERA) at Malvern and is now owned by QinetiQ. The SWIPSY firewall toolkit provides a means for hardening and configuring the Trusted Solaris 2.5.1 operating system such that it may be used as the platform for a firewall. The preferred version used to implement the present invention is SWIPSY version 1.6.

The preferred hardware for running the operating system and the toolkit is a SUN Microsystems Ultra 10 (440 MHz) containing two or more network cards. One network card is used for each domain to which the interface is connected as will be described in more detail later. It will be appreciated that the greater the number of network cards present in the hardware, the greater the number of domains that can be managed.

The present invention relates to an interface which uses the above hardware to manage a security system which allows SNMP and ICMP to be processed. The interface provides Management In Domain bAsed Secure Systems and is known as MIDASS.

As background, SNMP has several versions and version 3 (v3) is supported for encryption, timeliness and authentication of packets passed between a management node and MIDASS. Whilst version 1 (v1) and version 2c (v2c) are similar with v2c providing extra commands than v1, version 2 (v2) has more security than v1 but is effectively unusable for application in MIDASS. As a result, the most common versions of SNMP utilised in the industry are v1, v2c and v3. However, security domains operate on one version or the other and cannot interchange between the two. MIDASS has the ability to convert SNMPv3 to SNMPv2c and vice versa as will be described in more detail later.

Turning now to FIG. 1, three conventional security domains 10, 30, 50 are shown. Each domain is separate and may be located across a site, a country or the world, for example, branches of a bank or other organisation. Each domain 10, 30, 50 comprises two managed nodes 12, 14, 32, 34, 52, 54 and a management node 16, 36, 56 which comprises a management workstation operated by a human network administrator. In this case, either three network administrators are required (one for each domain) or a single network administrator who travels around all three domains. As shown, an Ethernet connection 18, 38, 58 is provided within each domain 10, 30, 50 and each management node 16, 36, 56 is connected to its associated Ethernet connection 18, 38, 58 by means of a respective connection 20, 40, 60. Similarly, each node 12, 14, 32, 34, 52, 54 is each connected to its respective Ethernet connection 18, 38, 58 via connections 22, 24, 42, 44, 62, 64 as shown.

It will be appreciated that although only two managed nodes are shown in each security domain, any other number of nodes may be present in the security domain.

In the domain arrangement shown in FIG. 1, there is a requirement for each domain 10, 30, 50 to have a management node 16, 36, 56 which manages network traffic on the Ethernet within the domain. The level of security within a security domain is determined in accordance with user requirements. This means that the transfer of information across domains becomes difficult if the integrity of each domain is to be maintained. As a result, there is an unnecessary cost due to the duplication of management nodes.

In accordance with the present invention, three security domains 10, 80, 100 can be managed from a single management node 16 as shown in FIG. 2. One human administrator is able to manage all three domains from a central location. Domain 10 is identical to domain 10 in FIG. 1 and will not be described again in detail here. Each security domain 80, 100 comprises two managed nodes 82, 84, 102, 104 connected to an Ethernet connection 88, 108 within the respective security domain 80, 100 by means of connections 92, 94, 112, 114 as shown. Again, more than two managed nodes may be connected to the respective Ethernet connections in security domains 80, 100.

A MIDASS firewall 70 is located between all three security domains 10, 80, 100 and is connected to the Ethernet connections 18, 88, 108 of each security domain by respective connections 116, 117, 118, as shown. The firewall 70 is multi-homed and allows more than one domain to be managed. However, the firewall 70 only allows, management traffic between secure domain 10 and secure domain 80 and between secure domain 10 and secure domain 100. No network traffic whatsoever is allowed between secure domain 80 and secure domain 100.

The MIDASS firewall 70 operates in conjunction with the management node 16 in security domain 10 to manage the other two security domains 80, 100. This means that security domain 10 comprises a ‘managing’ security domain, and each security domain 90, 110 comprises a ‘managed’ security domain. It is to be noted, however, that each security domain 10, 80, 100 still maintains its assigned security level.

It will be appreciated that although two ‘managed’ security domains are shown, any number of such domains may be connected to the firewall 70 provided it includes a network card for each security domain which is to be managed.

It is to be noted that SNMPv2c and SNMPv1 protocols incorporate very poor security. Their packets are very easy to read and copy off the network using simple tools. SNMPv3 on the other hand is very secure—providing encryption (privacy), authentication (guarantees sender), and timeliness (replay). This means a management command can be guaranteed to be coming from the manager and you can also be sure it has not been read.

MIDASS separates business information from management information because it only supports SNMP and ICMP. Files cannot be accessed through SNMP or ICMP. Moreover, MIDASS does not just pass packets through from the ‘managing’ domain to the ‘managed’ domain. It creates its own packets and prevents any direct communication between managed nodes in the secure domains. This adds an extra layer of security.

As background, the term protocol defines the code and pattern of the data packets which are sent between nodes on a network. The term packet describes a unit of data that is routed between an origin and a destination on a network, for example the Internet. A packet consists of several header sections containing source and destination addressing information as well as the section which contains the actual operational data being passed between nodes.

The functionality of the MIDASS firewall 70 is illustrated in FIGS. 3 and 4. Traffic passing through the firewall 70 to an Ethernet connection 120 is shown in FIG. 3. For each SNMP packet 122 passing through the firewall 70, its content and structure is checked. As shown, the packet 122 includes header information in the form of three structure elements: Ethernet information 124, Internet Protocol (IP) information 126, and User Datagram Protocol (UDP) information 128. SNMP element 130 represents the operational data.

FIG. 4 shows an ICMP packet 132 passing along an Ethernet connection 120. Here, two structure elements 124, 126 make up the header, namely, Ethernet information 124 and IP information 126 as described with reference to FIG. 3. The ICMP element 131 represents the operational data.

It will be appreciated that packets are processed by the firewall 70 such that only the operational data is passed between networks. No packets are transferred entirely and intact between networks.

In the case of both ICMP and SNMP the packets defined by the respective protocols can be subdivided into two categories: requests and responses. Packets from a management node are termed requests whilst packets from a managed node, usually sent as a result of the managed node receiving a request, are termed responses. Typically, the request packet operational data will contain some command and the response packet operational data will contain information supplied as a result of the managed node responding to the command. In the case of SNMP, the managed node can also send packets akin to unsolicited responses in order to send data to the management node.

In accordance with the present invention, the flow of network traffic between the security domains is restricted to a predetermined set of SNMP and ICMP request and response packets. These packets are authorised dependent on the network address from which they are sent, the network address to which they are sent, and the operational data contained therein. As well as these functional checks, ICMP and SNMP packets arriving at the firewall 70 undergo a byte level inspection to ensure their structure conforms to the appropriate protocol standards.

The packet inspection and processing functionality of the firewall 70 can be illustrated in greater detail with reference to the packet diagrams in FIGS. 3 and 4. As shown, the SNMP packet 122 includes three header elements—Ethernet element 124, IP element 126 and the UDP element 128—as well as the SNMP operational data 130. The ICMP packet 132 includes two header elements—Ethernet element 124 and IP element 126—as well as the ICMP operational data 131. Within the firewall 70, the structure of each of these elements is checked to ensure they contain the correct content in the correct position and that they contain no spurious data; any packets found to contain anomalies will be rejected. The firewall 70 also checks the actual source and destination addresses contained within the Ethernet, IP and UDP headers; any packets containing unrecognised addresses will be rejected.

For SNMP request packets, the firewall 70 examines the operational data along with the destination addresses from each of these header elements. It also checks whether the command in the operational data is permitted to be sent to that managed node indicated by the destination IP address. In this context the command includes the type of SNMP message (e.g. Get/Set) and the Object Identifier value to be set or retrieved. If the Object Identifier value at the destination IP address is not permitted to be acted upon by the SNMP message (e.g. Get/Set) then the request packet will be rejected.

For SNMP response packets, the firewall 70 examines the operational data along with the source addresses from these header elements and checks whether the information in the operational data, for example, SNMP object identifiers (OIDs) are permitted to be returned to a management node. In this context the command includes the type of SNMP message (e.g. Response) and the Object Identifier value being returned. If the Object Identifier value at the source IP address is not permitted to be returned then the SNMP response packet will be rejected. The firewall 70 will also check that the SNMP response packet is received as a result of a permitted SNMP request which was previously sent.

For ICMP request packets, the firewall 70 examines the operational data along with the destination addresses from each of the header elements. It also checks whether the ICMP packet type (e.g. ICMP Echo Request) is permitted to be sent to the managed node indicated by the destination IP address. If the packet is not permitted it will be rejected.

For ICMP response packets, the firewall 70 examines the operational data along with the destination addresses from each of the header elements and checks whether the ICMP response packet is received as a result of a permitted ICMP request which was previously sent.

In this way, the firewall 70 precisely controls which managed nodes within a security domain and which management information on those nodes may be accessed from a management node on a different security domain.

In FIG. 5, the firewall 70 is connected to security domains 80, 100 in a similar way to that shown in FIG. 2. As shown, managed node 82 in security domain 80 and managed node 104 in security domain 100 are shown as not being accessible to information passing through the firewall 70 whilst managed nodes 84 and 102 can access the same information. This means that the firewall 70 controls which nodes, hosts or computers that can be accessed across the firewall 70.

FIG. 6 shows an example of how the firewall 70 allows certain management information 106 on a managed node to be accessed whilst preventing access to other information. In this sample of data shown in FIG. 6, an SNMP request packet attempting to read or modify ‘sysUpTime’ and ‘sysContact’ would be allowed to enter the managed security domain by the firewall 70 whereas an SNMP request packet attempting to read or modify the other data would be prevented. Similarly, an SNMP response packet containing data related to ‘sysUpTime’ and ‘syscontact’ would be permitted to leave the security domain by the firewall 70 whereas an SNMP response packet containing the other data would be prevented.

The ability to prevent requests to and responses from specific managed nodes allows the overall architecture of a domain to be concealed and also allows specific management information on particular node to be kept private. This is very useful because it may not be advisable to open up an entire security domain to an external manager.

It has previously been noted that packets are processed by the firewall 70 such that only the operational data is passed between networks and that no packets are transferred entirely and intact between networks. If a packet received on one security domain is legitimate and permitted, then the firewall 70 will copy the destination address data and the operational data from that packet and will use this information to construct a new packet for injection onto the destination security domain. The original packet is then discarded. This method is known as hosting the packets.

As an extension to this packet hosting functionality, the firewall 70 is capable of translation between different versions of the SNMP protocol. The firewall 70 supports the use of SNMPv1 and SNMPv2c between a management node 16 and itself and also between a managed node 82, 84, 112, 114 and itself. In addition, the firewall 70 supports the use of SNMPv3 between a management node 16 and itself. When the firewall 70 receives an SNMPv3 request packet from the management node 16 which is destined for a managed node 82, 84, 112, 114, it will translate the request to SNMPv2c for injection onto the domain containing the managed nodes. The corresponding SNMPv2c response will be translated back to SNMPv3. This means that if the managing domain supports SNMPv3 and the managed domain supports SNMPv2c, the firewall 70 translates SNMPv3 to SNMPv2c and vice versa.

The advantage of the SNMPv3 protocol is that it can guarantee a packet's source and integrity through the use of timeliness, authentication and encryption. By supporting the use of SNMPv3 between itself and the management node, the firewall 70 can therefore guarantee the source and integrity of management commands. The authentication and encryption modules supplied with the firewall 70 support the HMAC-MD5, HMAC-SHA and CBC-DES algorithms. However, these modules are interchangeable and other algorithms may be easily incorporated.

Whilst it has been stated that MIDASS thoroughly checks packets for legality, MIDASS has an additional functionality. In effect, MIDASS controls exactly which nodes or computers may be managed and will only allow packets destined for these nodes or computers into the respective secure domain or network and then only to these nodes or computers.

It will be appreciated that MIDASS can be used to join any two TCP/IP domains, and it could, for example, be used in a situation where two separate entities are working on a common project and need to have access to information stored in each others' domains. Here, MIDASS would operate to separate business information and infrastructure information for each of the two entities whilst allowing the transfer of information relevant to the project.

As the likelihood and cost associated with a network based attack increase, network owners need to be confident that both the external and internal threats against their networks are being countered and that only the correct parties have access to the management of network resources. In addition, with the increased reliance on third party service providers for network management, network owners must be sure that the parties relied upon to manage their network resources are not able to access sensitive company data.

The present invention has been developed to enable secure monitoring and configuration of multiple networks operating at different levels of security. Thus, the owners of the networks can precisely control the access granted to the party charged with managing the assets on those networks. The present invention would therefore enable, for example, a single specialist IT service provider to manage all the network assets of a multi-location based company. In this scenario, the company owning the network could control which aspects of their assets the IT service provider could manage and, specifically, they could be sure the IT service provider was not able to access their business data.

In summary, the invention has the following features:
The invention can be used to join any Ethernet security domains without compromising their security, thus enabling remote management of the domains.
The invention provides unique functionality to inspect packet data and control the hosted passage of management requests and responses; thus controlling the transfer of management data between different security domains.
The invention provides the network owner with a mechanism to centralise the access control of all management data on a network.
The invention provides protocol translation.

Although only one management node is described in the embodiments above, it will be appreciated that more than one management node may be utilised in accordance with a particular application.

1. A system for managing security domains, the system comprising:
a plurality of security domains, each domain comprising at least one network having a plurality of managed nodes provided therein;
at least one management node located in one of said plurality of security domains for controlling operation of said plurality of managed nodes in said one security domain; and
a firewall located external of said one security domain which is operationally linked to the management node in said one security domain, the firewall linking said management node with said plurality of managed nodes in said plurality of security domains.

2. A system according to claim 1, wherein the firewall controls the network traffic by examining the source of the traffic, the destination of the traffic, and the operational content contained within that traffic.

3. A system according to claim 2, wherein the firewall converts one management protocol to another.

4. A system according to claim 3, wherein the firewall hosts Simple Network Management Protocol (SNMP).

5. A system according to claim 4, wherein, when the managing security domain hosts one version of SNMP and at least one of the managed security domain hosts another version of SNMP, the firewall converts one version of SNMP to another.

6. A system according to claim 5, wherein the managing security domain hosts several versions of SNMP and the managed security domains hosts less secure versions of SNMP.

7. A system according to claim 6, wherein the firewall converts SNMPv3 on the managed security domain to SNMPv2c on the managed security domains.

8. A system according to claim 1, wherein the firewall hosts a subset of Internet Control Management Protocol (ICMP).

9. A system according to claim 1, wherein the firewall prevents communication between one managed security domain and any other managed security domain.

10. A system according to claim 1, wherein the firewall controls access of information by each node in a managed security domain.

11. A method of centralizing access control information on managed nodes in a system for managing security domains according to claim 1.

12. (canceled)

13. A system according to claim 1, wherein the firewall converts one management protocol to another.

14. A system according to claim 13, wherein the firewall hosts Simple Network Management Protocol (SNMP).

15. A system according to claim 14, wherein, when the managing security domain hosts one version of SNMP and at least one of the managed security domain hosts another version of SNMP, the firewall converts one version of SNMP to another.

16. A system according to claim 15, wherein the managing security domain hosts several versions of SNMP and the managed security domains hosts less secure versions of SNMP.

17. A system according to claim 14, wherein the firewall converts SNMPv3 on the managed security domain to SNMPv2c on the managed security domains.

18. A system according to claim 3, wherein the firewall hosts a subset of Internet Control Management Protocol (ICMP).

19. A system according to claim 7, wherein the firewall prevents communication between one managed security domain and any other managed security domain.

20. A system according to claim 7, wherein the firewall controls access of information by each node in a managed security domain.

21. A method of centralizing access control information on managed nodes in a system for managing security domains according to claim 7.
